(19) United States
(12) Patent Application Publication
(10) Pub. No.: US 2017/0243682 A1
(43) Pub. Date: Aug. 24, 2017

(54) MAGNETIC DATE ERASER

(71) Applicant: ADVANCED DESIGN CORP., Kanagawa-ken (JP)

(72) Inventor: Tadashi HONDA, Kanagawa-ken (JP)

(21) Appl. No.: 15/052,228

(22) Filed: Feb. 24, 2016

(51) Int. Cl. H01F 7/06; G11B 33/04

(52) U.S. Cl. CPC H01F 7/064; G11B 33/04

(57) ABSTRACT

A magnetic data eraser includes: holding drawer means for holding a magnetic recording medium which means has a mounting tray for mounting the magnetic recording medium, the mounting tray being inclined a predetermined value of degrees of angle, and the iron plate attached at the front side and the rear side of the holding drawer means; magnetizing means for magnetizing the magnetic recording medium, the magnetizing means being configured to be covered by a magnetizing coil and has a hollow body portion, the holding drawer means being mounted in the hollow body portion, and the magnetic recording medium being placed on the mounting tray of the holding drawer means; and Control means for contouring the erase of the magnetic data recorded on the magnetic recording medium by flowing a current to the magnetic coil, and by erasing of data recorded on the magnetic recording medium.

### CROSS REFERENCE TO RELATED APPLICATION

The present application relates to and incorporated by reference Japanese Patent Application No. 2012-130760 filed on Jun. 8, 2012

### BACKGROUND OF THE INVENTION

The Field of the Invention

The present invention relates to a magnetic data eraser that is configured to erase magnetic data stored in a magnetic recording medium such as a hard disk drive and a magnetic tape.

Description of the Prior Arts

Nowadays, when a magnetic disk drive (hereinafter, it is exemplified by a hard disk drive) is intended to be discarded after it has been finished to be used in an office of a company or by an individual person, magnetic data should be erased by formatting the hard disk drive, for example, upon a request from an operating system in a computer while the hard disk drive is connected to the computer, in order to conceal the magnetic data stored in the hard disk drive from a third person, i.e., an unrelated person.

However, in the above mentioned method, only a management region of the hard disk which manages arrangement of magnetic information on the hard disk and the like may be erased, and actual magnetic information is remained on the hard disk. Thus, for example, a method for erasing information stored in the magnetic disk drive has been accepted to be carried out with applying magnetic force generated by an electromagnet on the magnetic disk drive.

Japanese Laid-Open Patent Application 2007-66439 discloses an invention relating to a data eraser that performs data erasing process with a simple operation to prevent the magnetic data stored in the magnetic recording medium to be discarded from leaking, in particular discloses an invention relating to a data eraser that performs data erasing process by applying horizontal magnetic field from a magnet on the magnetic recording medium.

However, recently a perpendicular magnetic recording method becomes to be adopted, and in the perpendicular magnetic recording, magnetic field being in a perpendicular direction is applied to the magnetic disk drive to store data in the magnetic recording medium. This perpendicular magnetic recording method may be more effective in comparison with an in-plane magnetic recording method (or horizontal magnetic recording method) which is one of the conventional recording methods including one disclosed in Japanese Laid-Open Patent Application 2007-66439, because the perpendicular magnetic recording method can provide an improved recording density of data in comparison with the in-plane magnetic recording method.

Hence, when data stored in the magnetic disk drive is intended to be erased, because the magnetic disk drive may utilize either the in-plane magnetic recording method or the perpendicular magnetic recording method and it cannot be determined which method is utilized only by looking its appearance, it has been needed to operate a data eraser to apply magnetic field being in the horizontal direction to the magnetic disk drive or to apply extremely strong magnetic field, and then further to apply magnetic field being in the perpendicular direction to the magnetic disk drive.

Therefore, there has been needed to take a longer time and complex operations to perform data erasing process for erasing date stored in a magnetic recording medium by using a conventional data eraser. Further, a large electric power has been needed to supply to an electromagnet to generate magnetic field to be used for applying to the magnetic recording medium.

Further, the magnetic disk apparatus is set to be inclined in the data erasing device. Then, a method for erasing data recorded over a magnetic field in the magnetic disk device is proposed.

However, the magnetic data erasing method for performing by setting inclined the magnetic disk device to the data erasing in the apparatus, a large leakage flux to the insertion direction of the magnetic disk device. Therefore, it is impossible to efficiently magnetized magnetic recording medium, which is an obstacle to data erasure of the magnetic recording medium.

### SUMMARY OF THE INVENTION

The present invention has been made taking the above mentioned problems into consideration, and an object of the present invention is to provide a magnetic data eraser (or a magnetizing apparatus or a degaussing apparatus) that is capable of the magnetization of the magnetic recording medium such as a magnetic disk apparatus or a magnetic tape efficiently perform well, that is capable of the reliably enables data erasure of a magnetic recording medium such as a magnetic disk apparatus or a magnetic tape.

According to a first aspect of the invention, the above mentioned problems are solved by providing a magnetic data eraser (or a magnetizing apparatus or a degaussing apparatus) that includes: holding drawer means for holding a magnetic recording medium which means has a mounting tray for mounting the magnetic recording medium, the mounting tray being inclined a predetermined value of degrees of angle, and the iron plate attached at the front side and the rear side of the holding drawer means; magnetizing means for magnetizing the magnetic recording medium, the magnetizing means being configured to be covered by a magnetizing coil and has a hollow body portion, the holding drawer means being mounted in the hollow body portion, and the magnetic recording medium being placed on the mounting tray of the holding drawer means; and control means for contouring the erase of the magnetic data recorded on the magnetic recording medium by flowing a current to the magnetic coil, and by erasing of data recorded on the magnetic recording medium.

Further, according to a second aspect of the invention, the above mentioned problems are solved by providing the magnetic data eraser (or a magnetizing apparatus or a degaussing apparatus) in which the magnetic recording medium is a hard disk drive or a magnetic tape.

Further, according to a third aspect of the invention, the above mentioned problems are solved by providing the magnetic data eraser (or a magnetizing apparatus or a degaussing apparatus) in which the holding drawer means for magnetic recording medium is mounted through the hollow portion and move in at least one direction, the magnetic recording medium installed in the hollow portion in the one direction when passing through.

### Advantages of the Invention

According to the present invention, a magnetic data eraser (or a magnetizing apparatus or a degaussing apparatus) that is capable of the magnetization of the magnetic recording medium such as a magnetic disk apparatus or a magnetic tape efficiently perform well, that is capable of the reliably enables data erasure of a magnetic recording medium such as a magnetic disk apparatus or a magnetic tape.

### BRIEF DESCRIPTION OF THE DRAWINGS

The present invention will be understood more fully from the detailed description to be given herein below and from the accompanying drawings of the preferred embodiment of the invention, which is not taken to limit the invention to the specific embodiments but should be recognized for the purpose of explanation and understanding only.

In the drawings:

FIG. 1 is a diagram illustrating a structure of a magnetizing apparatus (a magnetic data eraser) for a magnetic recording medium, the diagram being a front view of the magnetizer, according to an embodiment of the present invention;

FIG. 2 is a structure diagram of the magnetizing apparatus in which a covering door is open;

FIG. 3 is a side view of the mounting tray fixing tray;

FIG. 4 is a diagram illustrating a state in which a hard disk drive storing data being to be erased is mounted on a mounting tray of the mounting tray fixing tray;

FIG. 5 is a diagram illustrating an inside structure of the magnetizing apparatus;

FIG. 6 is a diagram showing a modification of the first embodiment, without providing an iron plate to mount the fixed part fitted with a hard disk, and a view for explaining the structure of Interior of the magnetizing apparatus showing a state in which a steel plate at the rear of the magnetizing apparatus;

FIG. 7 is a diagram showing a modification of the first embodiment without providing an iron plate to mount the fixed part fitted with a hard disk, and a configuration diagram of a magnetizing apparatus showing a state in which a steel plate in the door portion of the magnetizing apparatus;

FIG. 8 is a front top view of a mounting tray fixing tray;

FIG. 9 is a view for explaining the second embodiment, and shows a state fitted with a plurality of magnetic tapes for performing data erasing to the mounting base of the mount fixing portions; and

FIG. 10 is a view for explaining a magnetic data erase device of the third embodiment.

### DETAILED DESCRIPTION OF PREFERRED EMBODIMENTS

Some preferred embodiments of the present invention will be explained below with reference to attached drawings. Identical components are denoted by the same reference numerals throughout the drawings.

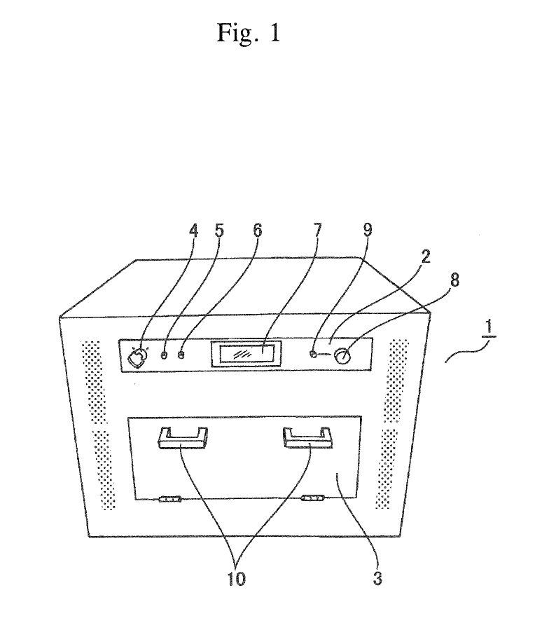

FIG. 1 is a diagram illustrating the structure of a magnetizing apparatus (a magnetic data eraser) for a magnetic recording medium, the diagram being a frontal inclined view of the magnetizer, according to an embodiment of the present invention. In FIG. 1, an operating display panel 2 and a door opening into the covering door 3 that is opened when a pullout cabinet that will be explained below is inserted are provided on the front surface of the magnetic data eraser 1. The operating display panel 2 has a power switch 4, a power indicator 5, an error indicator 6, a liquid crystal display 7, an operation start button 8, and a charging indicator lamp 9.

The power switch 4 is a switch for activating the magnetizing apparatus 1 of the present embodiment, and when the power switch 4 is switched on, electric power is supplied to the magnetizing apparatus 1 and the power indicator will light. The error indicator 6 will light when, for example, a thermometer to be explained below detects a temperature higher than a predetermined temperature, an abnormal electric current flows through the measurement winding (or a measuring coil) 20, abnormal behavior occurs in an activation circuit, or some other trouble occurs in the magnetizing apparatus 1. Further, the liquid crystal display 7 displays information about the error indicated by the error indicator 6.

The operation button 8 is a button that is pushed after a magnetic recording medium such as a hard disk drive (HDD), is mounted in the magnetizing apparatus 1, the pushing of said button activating the process by which data stored in the magnetic recording medium will be erased. Furthermore, the charging lamp 9 is a lamp that lights during the time that the electric power necessary to magnetize a magnetic recording medium for a process such as, for example, magnetic data erasing, is charged into a condenser (not shown) after the condenser has been discharged in a previous process.

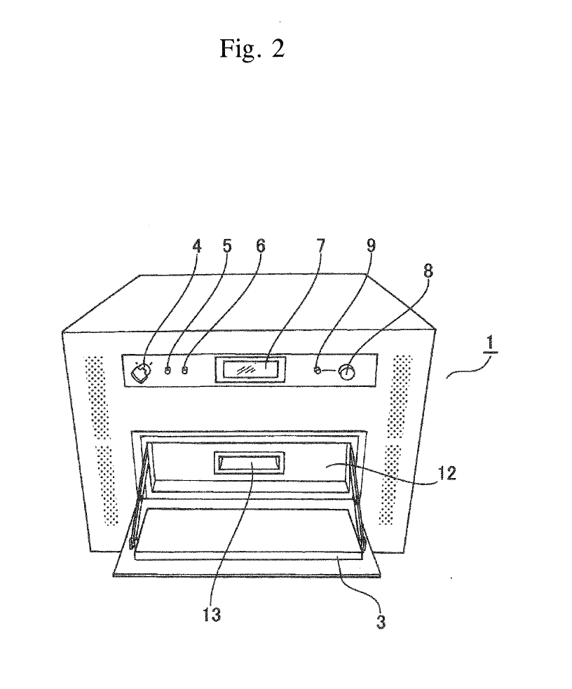

The covering door 3 is a door that is opened to allow the insertion of a pullout cabinet that will be explained below, and has one or more handles 10 on its front surface. For example, when a user grasps and pulls the handles 10, the covering door 3 opens toward the user. FIG. 2 is a structure diagram of the magnetizing apparatus in which the covering door 3 of the magnetizing apparatus 1 is open. In the state shown in FIG. 2, a pullout cabinet 12 is mounted in the magnetizing apparatus 1.

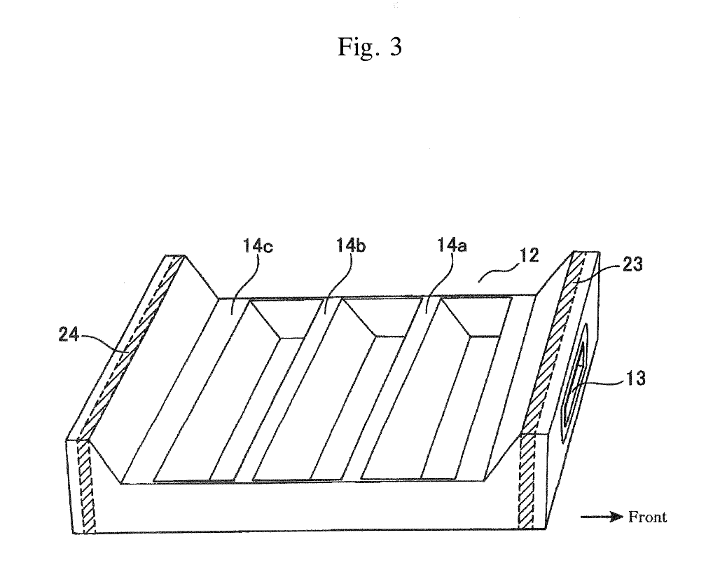

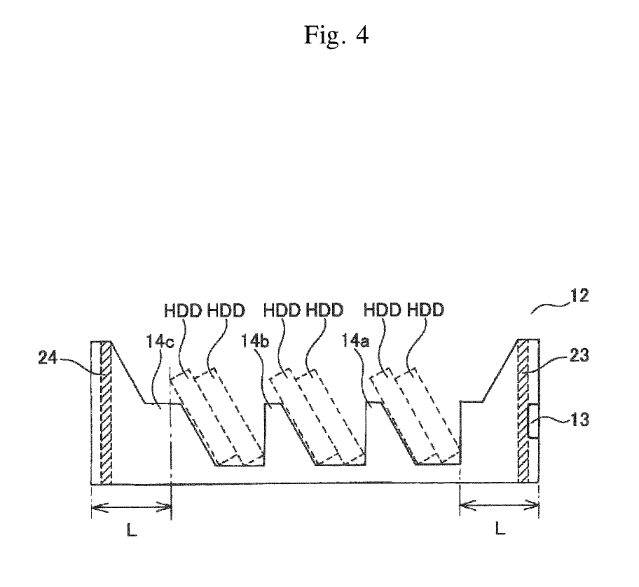

FIG. 3 is a frontal inclined view of the pullout cabinet 12 that is configured to be detachable from the magnetizing apparatus 1. A handle 13 is provided on a front surface of the pullout cabinet 12. The user can use the handle 13 to hold the pullout cabinet while inserting it 12 into the magnetizing apparatus 1. As shown in FIGS. 3 and 4, mounting trays 14a, 14b, 14c for magnetic recording media such as hard disk drives are provided as part of the pullout cabinet 12 in order to permit the insertion of multiple magnetic media such as HDD into positions from the front end to the back end of the pullout cabinet 12.

Incidentally, an example of using magnetic tape as a magnetic recording medium will be described in the second embodiment described later.

FIG. 4 is a diagram illustrating a state in which hard disk drives (HDDs) storing data being to be erased are mounted on the mounting trays 14a, 14b, 14c of the pullout cabinet 12. Each of the mounting trays 14a, 14b, 14c can hold two hard disk drives (HDD) and can immobilize the two hard disk drives (HDD) by a certain mechanism (not shown).

Furthermore, the symbol “L” in FIG. 4 indicates a predetermined length to be explained below. As will be explained in more detail, the predetermined length indicates a length at the front end and the back end of the pullout cabinet 12, and the mounting trays 14a, 14b, 14c are designed to prevent hard disk drives (HDDs) from being positioned in the areas indicated by the symbol “L”.

The pullout cabinet 12 of the present embodiment has an iron plate 23, 24 which is attached to the front and rear of the drawing direction. FIG. 3 shows a state where the iron plate 23, 24 is attached to the present embodiment. Arrangement position of the iron plate 23 and 24, the length from both ends of the pullout cabinet 12 (so-called margin) is attached to an arbitrary position within L. Incidentally, it can be used instead of the iron plate 23, 24 as long as the material can be avoided change effects and the flux angle of the decrease in magnetic field intensity formed by the magnetizing coil.

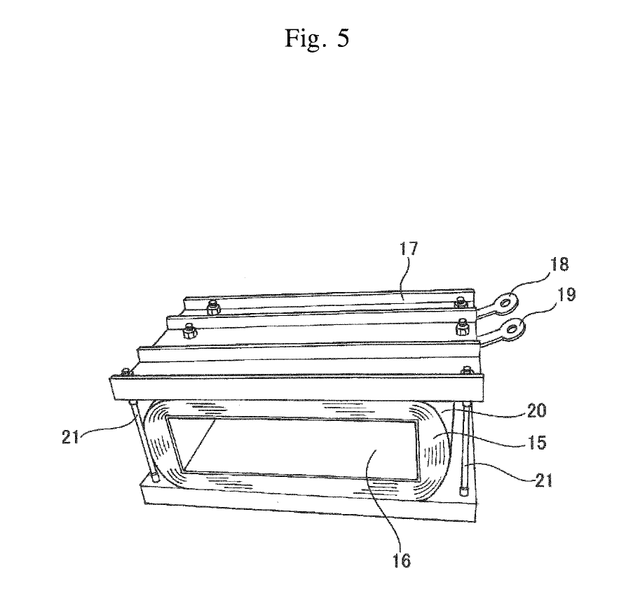

FIG. 5 is a diagram illustrating the inside structure of the magnetizing apparatus 1. In the magnetizing apparatus 1, a magnetizing coil 15, a hollow portion 16 into which the pullout cabinet 12 is inserted, and a heat sink 17 are provided. The magnetizing coil 15 is formed by winding a wire around the hollow portion 16, and the ends of the winding are connected to a power supply circuit (not shown) via leads 18, 19. It is possible to wind a standard round copper wire to form the magnetizing coil 15, but a flat wire or a rectangular wire, for example, can also be used as the winding.

The hollow portion 16 is sized to hold the pullout cabinet 12 mentioned above. In the hollow portion 16, the magnetic field generated by the magnetizing coil 15 is in a perpendicular direction from the plane of the front side of the equipment 1 to the plane of the rear side of the equipment 1, or in a perpendicular direction from the plane of the rear side of the equipment 1 to the plane of the front side of the equipment 1.

Therefore, if the iron plate 23, 24 described above to the pullout cabinet 12 is disposed, the pullout cabinet 12 to the hollow portion 16 is accommodated, iron plate 23, 24 is provided adjacent the front and back surfaces of FIG. 5. That is, the iron plate 23 disposed in close locations on the covering door 13 of the pullout cabinet 12 is located so as to cover the front of FIG. 5, the iron plate 24 which is disposed at the back of the pullout cabinet 12 to the rear surface of FIG. 5 is located so as to cover.

Further, 1-2 turns (T) of a measurement winding (that is, a measuring coil) 20 may be wound around the magnetizing coil 15. This measuring coil 20 is used to make measurements of the magnetic flux density of the magnetic field generated by the magnetizing coil 15, and the measured data may be sent to a controller via a lead (not shown). The electric current flowing through the measuring coil 20 may be used to light the indicator lamp (not shown) provided at the front surface of the magnetizing apparatus 1 so as to indicate to the user that the magnetizing process is proceeding.

A heat sink is provided that is in contact with the top surface and the bottom surface of the magnetizing coil 15, and is fixed to the magnetizing coil 15 by a fixing means 21.

Using the magnetizing apparatus 1 described above, the process for erasing data stored in a hard disk drive (HDD) would start with the step of pulling the pullout cabinet 12 from the magnetizing apparatus 1 followed by the step in which hard disk drives (HDDs) are mounted on the mounting trays 14a, 14b, 14c as shown in FIG. 5. Hence, the magnetizing apparatus 1 according to the present embodiment can hold 6 hard disk drives (HDDs) in the pullout cabinet 12.

Next, the user can insert the pullout cabinet 12 at a predetermined position in the magnetizing apparatus 1, and can close the covering door 4 using the handle 13 of the pullout cabinet.

At this stage, the user pushes the operation button 8 to cause electric current to flow through the magnetizing coil 15 from an electric current supplying circuit (not shown) and to excite the magnetizing coil 15, thereby generating a magnetic field in the hollow portion 16 of the magnetizing apparatus 1. This magnetic field is generated in a perpendicular direction from the plane of the back surface of the equipment to the plane of the front surface of the magnetizing apparatus 1 so that the magnetic field passes at a predetermined angle to the horizontal through the hard disk drive (HDD) mounted on the pullout cabinet 12 that is inserted to the hollow portion 16.

By this process, the hard disk is magnetized uniformly in one direction, so that data stored in the hard disk drive (HDD) is erased. Because the magnetic flux is passed through the hard disk drive at a 60 degree angle to the horizontal, it is ensured that magnetic data stored in either a hard disk drive (HDD) adopting a perpendicular magnetic recording method or a hard disk drive (HDD) adopting an in-plane magnetic recording method (or horizontal magnetic recording method) can be erased efficiently.

Further, as described above in apparatus of the present embodiment, the iron plate 23, 24 is attached to the pullout cabinet 12. When the pullout cabinet 12 insert in the hollow portion 16, the iron plate 23, 24 dispose at the front side and the rear side of the magnetizing coil 15 shown in FIG. 5. As described above, This magnetic field is generated in a perpendicular direction from the plane of the back surface of the equipment 1 to the front side of the equipment 1. In this case, the opposite ends of the magnetizing coil 15 are closed by the iron plate 23, 24. Therefore, it is possible to prevent the leakage flux from the opening formed when the iron plate 23, 24 is not attached.

That is, by providing the iron plate 23, 24 according to this embodiment, a reduction of both sides of the magnetic flux density of the magnetizing coil 15 can be prevented. Accordingly, this embodiment prevents a decrease in both sides of the magnetic flux density of the hollow portion 16, performs more reliably magnetizing process, It can be efficiently perform data erasure of the hard disk.

As described above, the present embodiment prevents a decrease in magnetic field strength on both sides of the magnetizing coil 15, performs efficiently magnetized, it can be surely perform data erasure of the hard disk.

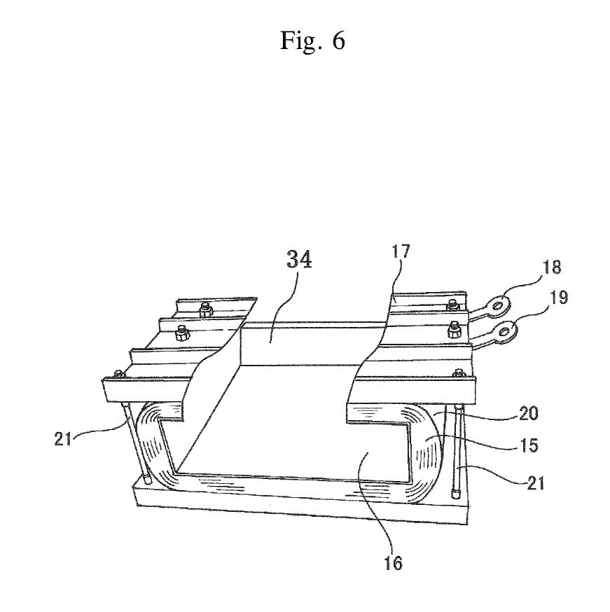

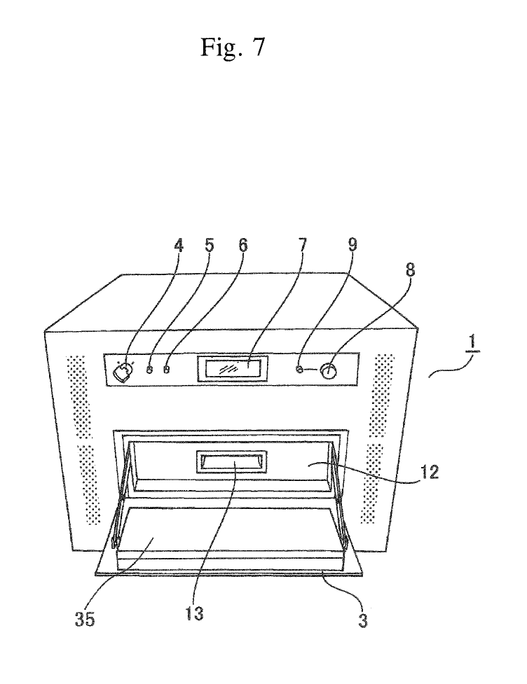

On the other hand, FIGS. 6 and 7 are views showing a modification of the first embodiment. Both figures is a diagram showing an example in which instead of providing the iron plate 23, 24 described above to mount the hard disk, provided in the magnetizing apparatus 1 side. FIG. 6 is a diagram showing a state without, where the iron plate 34 provided behind the magnetizing apparatus 1 providing a steel plate to a mounting base installing the hard disk. Further, FIG. 7 is a view showing a state in which an iron plate 35 to the covering door 3 of the magnetizing apparatus.

Specifically, the iron plate 34 provided at the rear of the magnetizing apparatus 1 shown in FIG. 6 corresponds to the iron plate 24 described above, the iron plate 35 provided to the covering door 3 of the magnetizing apparatus 1 shown in FIG. 7 of the aforementioned iron plate corresponds to 23, when the magnetic field is energized, by the iron plate 34, 35 provided on the portion other than the mounting base, to prevent magnetic flux leakage. That is, when mounting the lead pullout cabinet 12 in the hollow portion 16, the iron plate 35 provided to the covering door 3 of the magnetizing apparatus 1 covers the front of the magnetizing coil 15 shown in FIG. 5 described above, magnetizing device 1 iron plate 34 provided on the rear is to cover the back surface of the magnetizing coil 15.

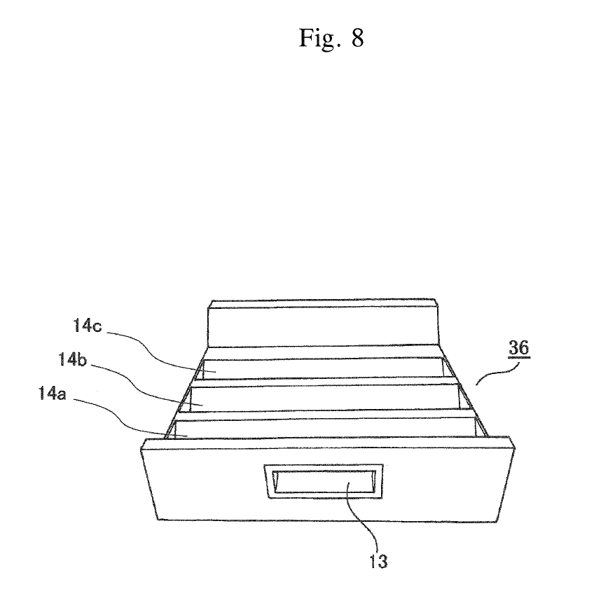

Accordingly, in this modification in place of the above-mentioned pullout cabinet 12 having an iron plate 23 and 24, the lead housing portion itself shown in FIG. 8 using the lead housing portion 36 having no iron plate. Incidentally, except having no iron plate to the lead housing portion itself, the other structure is the same as the aforementioned pullout cabinet 12, the mount six hard disk 14a, 14b, 14c are provided configuration or a configuration in which the handle 13 is provided is the same as that of the aforementioned pullout cabinet 12.

At this stage, the user pushes the operation button 8 to cause electric current to flow through the magnetizing coil 15 from an electric current supplying circuit (not shown) and to excite the magnetizing coil 15, thereby generating a magnetic field in the hollow portion 16 of the magnetizing apparatus 1. This magnetic field is generated in a perpendicular direction from the plane of the back surface of the equipment to the plane of the front surface of the magnetizing apparatus 1 so that the magnetic field passes at a predetermined angle to the horizontal through the hard disk drive (HDD) mounted on the pullout cabinet 12 that is inserted to the hollow portion 16.

In this case, the opposite ends of the magnetizing coil 15 are closed by the iron plate 34, 35. Therefore, it is possible to prevent the leakage flux from the opening formed when the iron plate 34, 35 is not attached. That is, by providing the iron plate 34, 35 according to this embodiment, a reduction of both sides of the magnetic flux density of the magnetizing coil 15 can be prevented. Accordingly, this embodiment prevents a decrease in both sides of the magnetic flux density of the hollow portion 16, performs more reliably magnetizing process, it can be efficiently perform data erasure of the hard disk.

As described above, the present embodiment prevents a decrease in magnetic field strength on both sides of the magnetizing coil 15, performs efficiently magnetized, it can be surely perform data erasure of the hard disk.

Incidentally, the iron plate to be used in this embodiment may be located at other than the above position. For example, it can be carried out in the same manner as long as the structure is provided at a position other than the mount for installing the hard disk. High permeability silicon steel, silicon steel strip or the like material may be used instead of the iron plates 23, 24, 34, and 35.

### Second Embodiment

A second embodiment of the present invention will be discussed below.

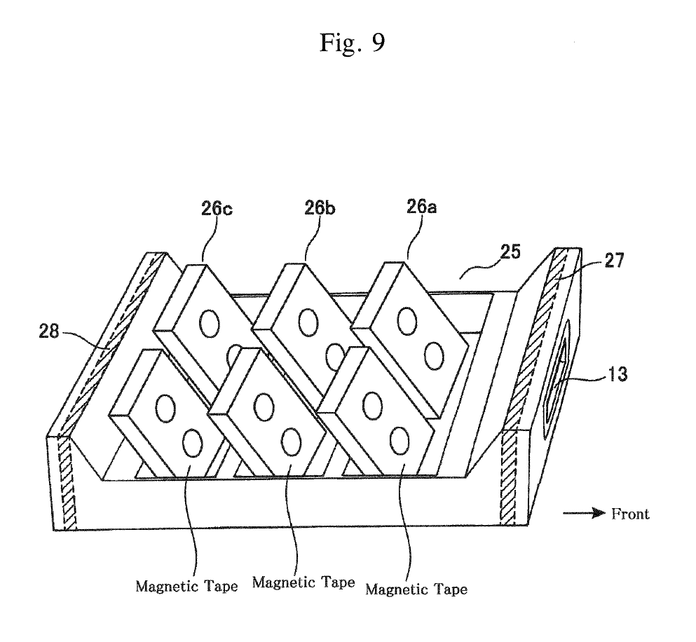

The second embodiment discloses an invention that provides a magnetic tape instead of the hard disk drive (HDD) as to a magnetic recording medium. FIG. 9 is a side inclined view of the pullout cabinet 25 that is configured to be detachable from the magnetizing apparatus 1. Mounting trays 26a, 26b, 26c for magnetic recording media such as the magnetic tapes are provided as part of the pullout cabinet 25 in order to permit the insertion into positions from the front end to the back end.

All of the mounting trays 26a, 26b and 26c can be set at an angle of, for example, predetermined angle to the horizontal. However, it is allowable for the angles of incline of the mounting trays 26a, 26b and 26c.

As shown in FIG. 9, each of the mounting trays 26a, 26b, 26c can hold two magnetic tapes and can immobilize the two magnetic tapes by a certain mechanism (not shown). As described above, each of the mounting trays 26a, 26b, 26c may be inclined at a predetermined angle toward the horizontal plane (the bottom surface of the pullout cabinet 25) so that the magnetic tapes mounted on the pullout cabinet 25 will be inclined at a predetermined angle toward the horizontal plane.

An inside structure of the magnetizing apparatus 1 is same as above-mentioned, the hollow portion 16 of the magnetizing apparatus 1 is sized to hold the pullout cabinet 25 mentioned above. The pullout cabinet 25 mounted on the magnetic tapes are set to the hollow portion 16.

Using the magnetizing apparatus 1 described above, the process for erasing data stored in the magnetic tape would start with the step of pulling the pullout cabinet 25 from the magnetizing apparatus 1 followed by the step in which the magnetic tapes are mounted on the mounting trays 26a, 26b, 26c as shown in FIG. 9. Hence, the magnetizing apparatus 1 according to the present embodiment can hold 6 magnetic tapes in the pullout cabinet 25.

Next, the user can insert the pullout cabinet 25 at a predetermined position in the magnetizing apparatus 1, and can close the covering door 3 using the handle 13 of the pullout cabinet 25. Then, described above, the user pushes the operation button 8 to cause electric current to flow through the magnetizing coil 15 from an electric current supplying circuit (not shown) and to excite the magnetizing coil 15, thereby generating a magnetic field in the hollow portion 16 of the magnetizing apparatus 1.

This magnetic field is generated in a perpendicular direction from the plane of the back surface of the equipment to the plane of the front surface of the magnetizing apparatus 1 so that the magnetic field passes at a predetermining angle to the horizontal through the magnetic tape mounted on the pullout cabinet 12 that is inserted to the hollow portion 16.

By this process, the magnetic tape is magnetized uniformly in one direction, so that data stored in the magnetic tape is erased. Because the magnetic flux is passed through the magnetic tape at a predetermined angle to the horizontal, it is ensured that magnetic data stored in either the magnetic tape adopting a perpendicular magnetic recording method or the magnetic tape adopting an in-plane magnetic recording method (or horizontal magnetic recording method) can be erased efficiently.

Furthermore, as described above in apparatus of the present embodiment, the iron plate 27, 28 is attached to the pullout cabinet 25. When the pullout cabinet 25 insert in the hollow portion 16, the iron plate 27, 28 dispose at the front side and the rear side of the magnetizing coil 15 shown in FIG. 5. As described above, this magnetic field is generated in a perpendicular direction from the plane of the back surface of the equipment 1 to the front side of the equipment 1. In this case, the opposite ends of the magnetizing coil 15 are closed by the iron plate 27, 28. Therefore, it is possible to prevent the leakage flux from the opening formed when the iron plate 27, 28 is not attached.

### Third Embodiment

A third embodiment of the present invention will be discussed below.

In the description of the above embodiment, the mount 14a for attaching the magnetic recording medium such as a hard disk or a magnetic tape, 14b, 14c (26a, 26c, 26c) and has been a configuration in which the pullout cabinet 12 (25), as the mount fixing portion not necessarily to be limited to the pullout cabinet 12 (25), it may be pre-installed in the mount fixing portion configured to attach mount a magnetic recording medium such as a hard disk or a magnetic tape directly into the hollow portion 16 described above.

For example, the mount fixed portion 30 of the belt conveyor type is provided instead of the pullout cabinet 12 (25). Magnetic recording medium such as a hard disk or a magnetic tape is sequentially attached to the mounting base 30a, 30b, . . . of the mount fixing portion 30. And magnetic recording medium such as a hard disk or magnetic tape is a hollow portion 16 from the front to the back side, or continuously moved to the front from the back side, automatically perform a data erasure of magnetic recording media.

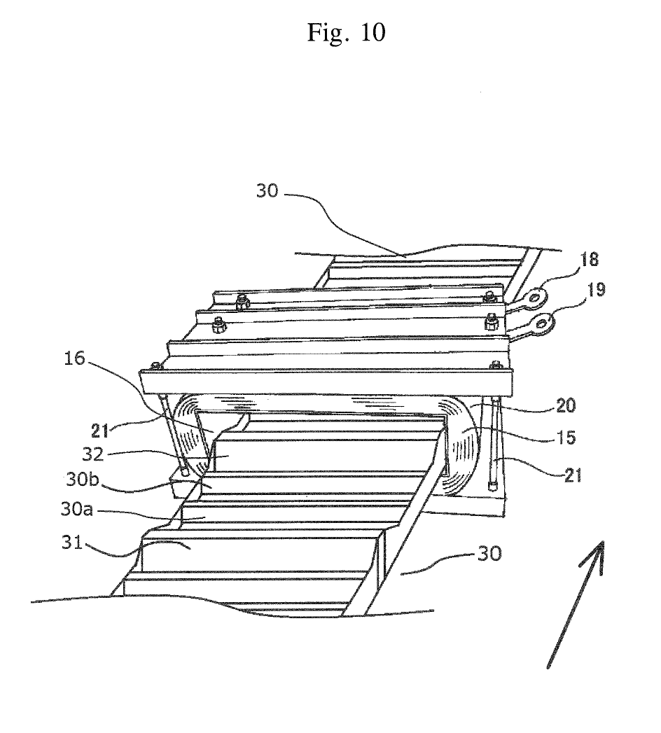

FIG. 10 is a view for explaining a magnetic data erase device configured as described above. The magnetic data eraser shown in the figure is an example using the mount fixing portion 30 for the mounting base has two provided for attaching a magnetic recording medium such as a hard disk or a magnetic tape.

As shown in the drawing, the mount fixing portions 30 of the belt conveyor type is movable in the direction of the arrow. Magnetic recording medium such as a hard disk or a magnetic tape on the mounting base 30a, 30b provided on the mount fixing portion 30 are sequentially carried in the hollow portion 16 of the magnetic data erasing device according to the movement in the arrow direction. The magnetic recording medium which is conveyed into the hollow portion 16 as described above, is magnetized by the magnetic force, erasure of magnetic data.

In this embodiment, the belt conveyor type mount fixing portion 30 of which moves in the arrow direction, it is continuously performed by sequentially placing a magnetic recording medium such as a hard disk or a magnetic tape. Therefore, according to the magnetic data eraser of the present embodiment, it is possible to perform data erasure efficiently magnetic recording medium.

Specifically, at the timing for performing data erasing process, both ends of the magnetizing coil 15 to move to a position which is closed by iron plates 31 and 32, controls the movement of the mount fixing portion 30. That is, the iron plate 31 and 32 provided at predetermined intervals, by controlling the movement of the mount fixing unit 30, sets a timing at which the opposite ends of the magnetizing coil forming portion 15 is closed by the iron plate 31, 32. By data erasure of the magnetic recording medium at this timing, reduction of both sides of the magnetic flux density of the hollow portion 16 is prevented. It performed more reliably magnetizing process, more efficiently can perform data erasure of the magnetic tape.

The configuration as in the above example of FIG. 10 has been described mount fixing portions 30 of the belt conveyor type from the front side move to the back side, continuously moving the mount fixing portion 30 from the rear side move to the front side.

What is claimed is:

1. A magnetic data eraser, comprising:
holding drawer means for holding a magnetic recording medium which means has a mounting tray for mounting the magnetic recording medium, the mounting tray being inclined a predetermined value of degrees of angle, and the iron plate attached at the front side and the rear side of the holding drawer means;
magnetizing means for magnetizing the magnetic recording medium, the magnetizing means being configured to be covered by a magnetizing coil and has a hollow body portion, the holding drawer means being mounted in the hollow body portion, and the magnetic recording medium being placed on the mounting tray of the holding drawer means; and
control means for contouring the erase of the magnetic data recorded on the magnetic recording medium by flowing a current to the magnetic coil, and by erasing of data recorded on the magnetic recording medium.

2. The magnetic data eraser according to claim 1, wherein the iron plate provides on the portion other than the holding drawer means.

3. The magnetic data eraser according to claim 1, wherein the magnetic recording medium is a hard disk drive or a magnetic tape.

4. The magnetic data eraser according to claim 1, wherein the iron plate is located within a certain range of the front and rear of the holding drawer means.

5. The magnetic data eraser according to claim 1, wherein the magnetic recording medium is plurality and hold a plurality of mounting tray.

6. The magnetic data eraser according to claim 1, wherein the holding drawer means for magnetic recording medium is mounted through the hollow portion and move in at least one direction, the magnetic recording medium installed in the hollow portion in the one direction when passing through.
